(19) United States
(12) Patent Application Publication
(10) Pub. No.: US 2015/0033110 A1
(43) Pub. Date: Jan. 29, 2015

(54) ELECTRONIC BOOK DISPLAYING SCHEME

(71) Applicant: KT Corporation, Seongnam-si (KR)

(72) Inventor: Sung-eun PARK, Gwacheon-si (KR)

(21) Appl. No.: 14/332,497

(22) Filed: Jul. 16, 2014

(30) Foreign Application Priority Data
Jul. 23, 2013 (KR) 10-2013-0086806

(51) Int. Cl. G06F 17/24

(52) U.S. Cl. CPC G06F 17/241
USPC 715/230

(57) ABSTRACT

In one example embodiment, a server includes a database configured to receive, from multiple devices, annotations regarding a page of an e-book; an annotation integrator configured to combine two or more of the annotations regarding the page; and a transmitter configured to transmit, to a user device, the combined annotations regarding the page of the e-book.

### TECHNICAL FIELD

The embodiments described herein pertain generally to an electronic book display scheme.

### BACKGROUND

An electronic book (E-book) is generically known as a digital book. More particularly, publications or books may be recorded in an electronic recording medium or remote storage device, for users to access via computers or portable terminals.

### SUMMARY

In one example embodiment, a server may include a database configured to receive, from multiple devices, annotations regarding a page of an e-book; an annotation integrator configured to combine two or more of the annotations regarding the page; and a transmitter configured to transmit, to a user device, the combined annotations regarding the page of the e-book.

In another example embodiment, a computer-readable storage medium having thereon computer-executable instructions that, in response to execution, cause a device to perform operations including: receiving, from multiple devices, annotations regarding a page of an e-book; combining two or more of the annotations regarding the page from among the annotations; and transmitting, to a user device, the combined two or more of the annotations.

In yet another example embodiment, a system may include: a user device configured to: transmit a request for annotations regarding a page of an e-book. The system may also include a server configured to: combine multiple annotations made to the page of the e-book, and transmit, to the user device, the combined annotations. The user device is further configured to display the combined annotations.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent from the following detailed description. The use of the same reference numbers in different figures indicates similar or identical items.

FIG. 1 shows an example system in which an electronic book displaying scheme may be implemented, in accordance with various embodiments described herein;

FIG. 2 shows an illustrative example device by which at least portions of an electronic book displaying scheme may be implemented, in accordance with various embodiments described herein;

FIGS. 3A and 3B show another illustrative example device by which at least portions of an electronic book displaying scheme may be implemented, in accordance with various embodiments described herein;

FIGS. 4A and 4B show still another illustrative example device by which at least portions of an electronic book displaying scheme may be implemented, in accordance with various embodiments described herein;

FIG. 5 shows still another illustrative example device by which at least portions of an electronic book displaying scheme may be implemented, in accordance with various embodiments described herein;

FIG. 6 shows an illustrative example server by which at least portions of an electronic book displaying scheme may be implemented, in accordance with various embodiments described herein;

FIG. 7 shows an example processing flow of operations by which at least portions of an electronic book displaying scheme may be implemented, in accordance with various embodiments described herein;

FIG. 8 shows another example processing flow of operations by which at least portions of an electronic book displaying scheme may be implemented, in accordance with various embodiments described herein; and

FIG. 9 shows an illustrative computing embodiment, in which any of the processes and sub-processes of an electronic book displaying scheme may be implemented as computer-readable instructions stored on a computer-readable medium, in accordance with various embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

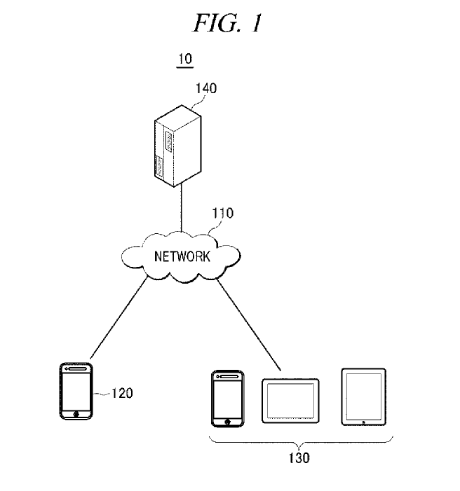

FIG. 1 shows an example system 10 in which an electronic book displaying scheme may be implemented, in accordance with various embodiments described herein. As depicted in FIG. 1, system 10 may include, at least, a user device 120, one or more end devices 130, and a server 140. At least two or more embodiments of user device 120, one or more end devices 130, and server 140, respectively, may be communicatively connected to each other via a network 110. Unless context requires otherwise, collective reference may be made to end devices 130; and representative reference may be made to end devices 130.

Network 110 may include, as non-limiting examples, a wireless network such as a mobile radio communication network including at least one of a 3rd generation (3G), 4^{th} generation (4G), or 5^{th} generation (5G) mobile telecommunications network, various other mobile telecommunications networks, a satellite network, WiBro (Wireless Broadband Internet), Mobile WiMAX (World Interoperability for Microwave Access), HSDPA (High Speed Downlink Packet Access), Bluetooth, or the like.

Respective ones of user device 120 and one or more end devices 130 may refer to, as non-limiting examples, a notebook computer, a personal computer, a smart phone, a smart television, a digital camera, a tablet computer, a phablet device, or a personal communication terminal, such as PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro terminal.

Server 140 may refer to one or more servers, processing apparatuses, or computing devices hosted and/or supported by a service provider that may transmit electronic book content and multiple annotations, which are associated with the electronic book content, to multiple devices including the one or more embodiments of user device 120 and one or more end devices 130. Server 140 may also be configured to receive, from one or more end devices 130, multiple annotations regarding a page of an electronic book; to receive, from user device 120, a request for the annotations regarding the page of the electronic book; to integrate the requested annotations; and to transmit, to user device 120, the integrated annotations regarding the page of the electronic book.

In some embodiments, a user of end device 130 may generate one or more annotations regarding a page of an electronic book, which is displayed on a touch screen that is communicatively coupled to end device 130. The user of end device 130 may generate the annotations regarding one or more words on a page of the electronic book by using a finger or a stylus pen. For example, but not as a limitation, the annotations may include a handwritten note or a manually entered highlighting annotation. Further, as non-limiting examples, the highlighting annotation may include at least one of an asterisk, a circle, a box, underlining or colored highlighting. A type or kind of highlighting annotation may not be limited to an asterisk, a circle, a box, underlining or colored highlighting, and may be changed. Thus, the user of end device 130 may enter handwritten notes or annotations with regard to one or more words on the page.

Respective ones of end devices 130 may be configured to transmit, to server 140, the generated annotations regarding the page of the electronic book. For example, in some embodiments, end device 130 may be configured to receive a user input to turn the page, and end device 130 may transmit the annotations on the page to server 140 upon receiving the user input to turn the page.

Server 140 may be configured to receive the annotations from respective ones of end devices 130. Server 140 may be further configured to interpret handwriting using any well-known alphanumeric character recognition methods, to identify words included in the annotations on the page of the electronic book. In some embodiments, server 140 may be configured to further recognize an arrow or a line that is drawn between the handwriting and the respective word using well-known alphanumeric character recognition methods. Thus, server 140 may associate and/or connect the identified words with the respective handwriting based at least in part on the recognized arrow or line.

Server 140 may also be further configured to classify the handwritten annotations into one of multiple classifications, e.g., handwritten note, an asterisk, a circle, a box, underlining or colored highlighting. Thus, server 140 may match respective word on the page of the electronic book with the classified handwritten annotations which are made to the respective word. Server 140 may be further configured to store, in a database, a combination or a set of respective word and one or more handwritten annotations that are made to the respective word.

Server 140 may also be configured to store, in a database, the annotations in association with the respective ones of end devices 130. In some embodiments, server 140 may be configured to attribute the annotations to an annotator using profile information regarding one or more of end devices 130. For example, server 140 may be configured to match and/or store, in the database, respective annotations with a user account of the user who generated the respective annotation. The user account may be authenticated on respective ones of end devices 130.

Server 140 may also be configured to receive, from user device 120, a request for one or more of the annotations that are annotated on the page of the electronic book, check whether annotations regarding the requested page of the electronic book are stored in the database, and transmit, to user device 120, an annotation list of options regarding displaying the annotations on the page of the electronic book, to provide the requested page of the electronic book and associated annotations to user device 120, if the annotations regarding the requested page are stored in the database. For example, but not as a limitation, the transmitted annotation list may include a first annotation that may be generated by a user of a first device from among end devices 130, a second annotation that may be generated by a user of a second device from among end devices 130 and a third annotation that may be generated by a user of a third device from among end devices 130. Further, server 140 may be configured to transmit, to user device 120, an annotator list that identifies one or more annotators (e.g., user accounts for the first device, second device and third device) corresponding to the respective ones of the annotations (e.g., first annotation, second annotation and third annotation), along with the annotation list of options.

Server 140 may also be configured to receive, from user device 120, user input to select one or more annotations regarding the page from the annotation list of options. Server 140 may be further configured to combine two or more of the annotations regarding the page when server 140 receives the user input to select one of the options. For the above example, if server 140 receives, from user device 120, user input to select the first annotation and second annotation from among the annotation list, server 140 may combine the first annotation and the second annotation regarding the page of the electronic book; transmit, to user device 120, the combined annotations regarding the page of the electronic book; and display the page of the electronic book and the received combined annotations (e.g., the first annotation and the second annotation) regarding the page of the electronic book on a display, which is communicatively coupled to user device 120.

In some embodiments, server 140 may be configured to count a number of words to which at least one annotation is attached on the page of the e-book, and to count a number of annotations that are attached to the respective words. For example, server 140 may count a number of words that are underlined or highlighted on the page of the e-book; count a number of words to which a handwritten note is attached; or count a number of words to which an asterisk, a circle or a box is associated. Thus, in some embodiments, server 140 may be further configured to emphasize one or more words on the page based at least in part on the number of words to which the at least one annotation is attached and the number of annotations that are attached to the words, emphasize a word on the page when the word is underlined or highlighted and a circle or a box is made to the word on the page of the e-book, emphasize the word by changing a color of a font of the emphasized the word, a size of the font of the emphasized the word, or the font of the emphasized the word.

Further, server 140 may be configured to transmit, to user device 120, the page of the electronic book, on which one or more words are emphasized. That is, user device 120 may display, on a display that is communicatively coupled to user device 120, the page of the electronic book, in which one or more words having emphasized color or font are included.

In some embodiments, server 140 may be configured to integrate multiple annotations that are made regarding an occurrence of a particular word. For example, if multiple highlighting annotations or multiple handwritten annotations are attached to a particular word on a page of an electronic book, server 140 may integrate the multiple highlighting annotations or multiple handwritten annotations to emphasize the particular word.

Further, server 140 may be configured to transmit, to user device 120, the integrated annotations regarding the word on the page of the electronic book. Then, user device 120 may be configured to display the page of the electronic book and the integrated annotations regarding the word on the page of the electronic book on a display, which is communicatively coupled to user device 120.

Thus, it is possible to share other user's (e.g., users of end devices 130) comments or thoughts included in the integrated annotations regarding one or more words on a page of the electronic book.

Thus, FIG. 1 shows example system 10 in which an electronic book displaying scheme may be implemented, in accordance with various embodiments described herein.

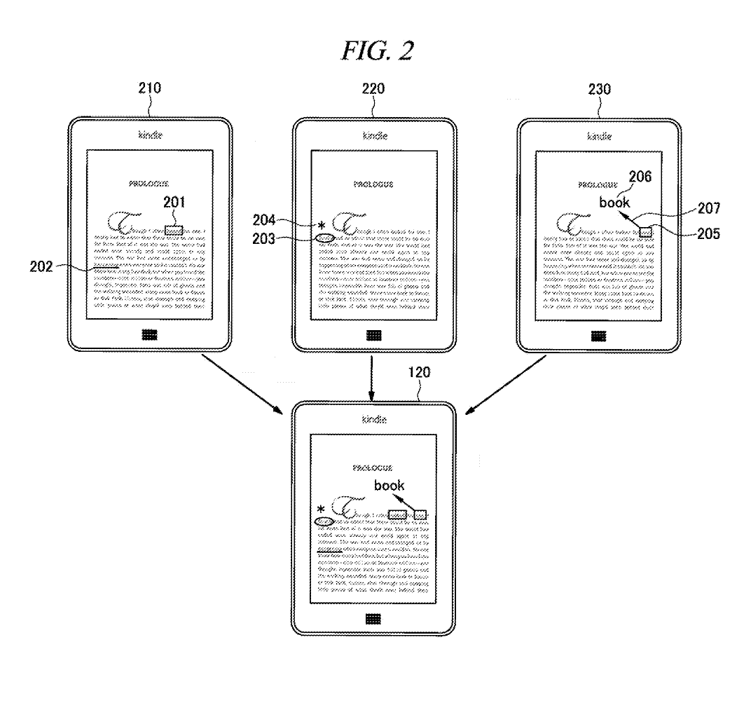

FIG. 2 shows an illustrative example device by which at least portions of an electronic book displaying scheme may be implemented, in accordance with various embodiments described herein. For example, as depicted in FIG. 2, a first end device 210 may be configured to display a page of an electronic book on a corresponding display. Further, a user of first end device 210 may generate a first annotation 201 regarding a first word on the page of the electronic book and generate a second annotation 202 regarding a second word on the page of the electronic book. Further, first end device 210 may display first annotation 201 and second annotation 202 on the page of the electronic book on the display of first end device 210. As depicted in FIG. 2, for example, first annotation 201 may be a hand drawn box that surrounds the first word and second annotation 202 may be underlining of the second word. A type or kind of first annotation 201 and second annotation 202 are not limited to the hand drawn box and underlining.

In some embodiments, first end device 210 may be configured to transmit, to server 140, first annotation 201 and second annotation 202 upon receiving user input to turn the page when first annotation 201 and second annotation 202 have been added to the page. The number of annotations to be transmitted to server 140 may not be limited to two (e.g., first annotation 201 and second annotation 202), and may be changed. Further, the event or command that may cause the annotations (e.g., first annotation 201 and second annotation 202) to be transmitted to server 140 is not limited to the turning the page. For example, first end device 210 may transmit, to server 140, first annotation 201 and second annotation 202 in response to a corresponding voice command.

Further, as depicted in FIG. 2, a second end device 220 may be configured to display the same page of the electronic book as displayed on first end device 210. Further, a user of second end device 220 may generate a third annotation 203 regarding a third word on the page of the electronic book, and generate a fourth annotation 204 regarding the third word on the page of the electronic book. Further, second end device 210 may be configured to display third annotation 203 and fourth annotation 204 on the page of the electronic book on the display of second end device 220. As depicted in FIG. 2, for example, third annotation 203 may be a circle that surrounds the third word and fourth annotation 204 may be an asterisk attached to the third word. A type or kind of third annotation 203 and fourth annotation 204 are not limited to the circle and asterisk.

In some embodiments, second end device 220 may be configured to transmit, to server 140, third annotation 203 and fourth annotation 204 upon receiving user input to turn the page when third annotation 203 and fourth annotation 204 have been added to the page. The number of annotations to be transmitted to server 140 is not limited to two (e.g., third annotation 203 and fourth annotation 204). Further, the event or command that may cause the annotations (e.g., third annotation 203 and fourth annotation 204) to be transmitted to server 140 is not limited to the turning the page. For example, second end device 220 may transmit, to server 140, third annotation 203 and fourth annotation 204 in response to a corresponding voice command.

Further, as depicted in FIG. 2, a third end device 230 may be configured to display the same page of the electronic book as does second end device 220. Further, a user of third end device 230 may generate a fifth annotation 205 regarding a fourth word on the page of the electronic book and generate a sixth annotation 206 regarding the fourth word on the page of the electronic book and generate an arrow 207 between sixth annotation 206 and the fourth word. Further, third end device 230 may be configured to display fifth annotation 205, sixth annotation 206 and arrow 207 on the displayed page of the electronic book. As depicted in FIG. 2, for example, fifth annotation 205 may be a hand drawn box that surrounds the fourth word and sixth annotation 206 may be a handwritten note (e.g., book). A type or kind of fifth annotation 205 and sixth annotation 206 are not limited to the hand drawn box and handwritten note.

In some embodiments, third end device 230 may be configured to transmit, to server 140, fifth annotation 205, sixth annotation 206 and arrow 207 upon receiving user input to turn the page when fifth annotation 205, sixth annotation 206 and arrow 207 have been added to the page. The number of annotations to be transmitted to server 140 is not limited to three (e.g., fifth annotation 205, sixth annotation 206 and arrow 207). Further, the event or command that may cause the annotations (e.g., fifth annotation 205, sixth annotation 206 and arrow 207) to be transmitted to server 140 is not limited to the turning of a page. For example, third end device 230 may transmit, to server 140, fifth annotation 205, sixth annotation 206 and arrow 207 upon receiving a voice command to execute the transmission.

In some embodiments, server 140 may be configured to receive, from user device 120, a request for annotations regarding the page of the electronic book. Server 140 may be further configured to integrate multiple annotations regarding the page of the electronic book, and transmit the integrated multiple annotations regarding the page of the electronic book to user device 120. Further to the above example, user device 120 may be configured to receive, from server 140, the integrated first annotation 201, second annotation 202, third annotation 203, fourth annotation 204, fifth annotation 205, sixth annotation 206 and arrow 207 regarding the same page of the electronic book. Further, as depicted in FIG. 2, user device 120 may be configured to display the integrated first annotation 201, second annotation 202, third annotation 203, fourth annotation 204, fifth annotation 205, sixth annotation 206 and arrow 207 on the page of the electronic book on a display of user device 120.

Thus, first annotation 201, second annotation 202, third annotation 203, fourth annotation 204, fifth annotation 205, sixth annotation 206 and arrow 207 that are annotated on the page of the electronic book by users of first end device 210, second end device 220 and third end device 230 may be shared with a user of user device 120.

Thus, FIG. 2 shows an illustrative example device by which at least portions of an electronic book displaying scheme may be implemented, in accordance with various embodiments described herein.

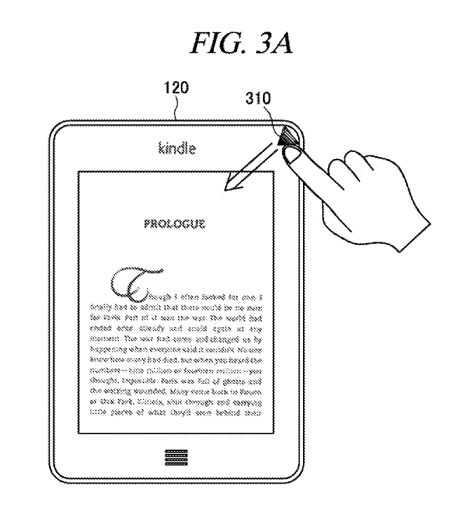

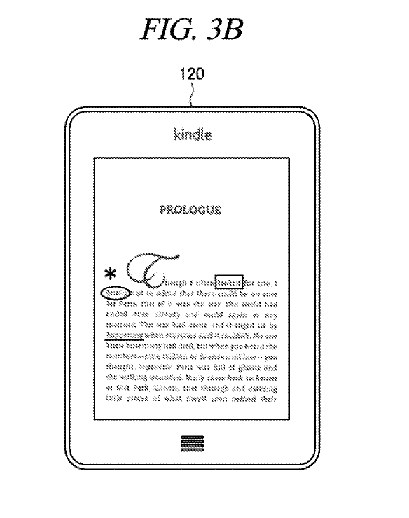

FIGS. 3A and 3B show another illustrative example device by which at least portions of an electronic book displaying scheme may be implemented, in accordance with various embodiments described herein. User device 120 may be configured to display a page of an electronic book on a display that is communicatively coupled to user device 120; and transmit, to server 140, a request for annotations regarding the page of the electronic book upon receiving user input by activating a corresponding command prompt. For example, as depicted in FIG. 3A, a user of user device 120 may touch a portion 310 (e.g., upper right corner) on the display of user device 120, and drag the touch to a predefined direction (e.g., lower left side). Portion 310 is not limited to the upper right corner on the display of user device 120. For example, any portion on the display of user device 120 may be designated for such purpose; or, alternatively, a touch pattern on the display may be so implemented. User device 120 may be configured to identify the user touch input, and then to transmit, to server 140, the request for the annotations regarding the page of the electronic book.

Server 140 may be configured to receive, from user device 120, the request for the annotations regarding the page of the electronic book; check whether annotations that have been made to the page of the electronic book are stored in a database; and combine the annotations regarding the page of the electronic book (e.g., an asterisk, a circle, a box and underlining). Further, server 140 may be configured to transmit, to user device 120, the combined annotations regarding the page of the electronic book. Further, as depicted in FIG. 3B, user device 120 may display the transmitted combined annotations regarding the page of the electronic book on the display of user device 120.

Thus, the annotations (e.g., an asterisk, a circle, a box and underlining) regarding the page of the electronic book that are annotated on the page of the electronic book by other readers may be shared with a user of user device 120.

Thus, FIGS. 3A and 3B show another illustrative example device by which at least portions of an electronic book displaying scheme may be implemented, in accordance with various embodiments described herein.

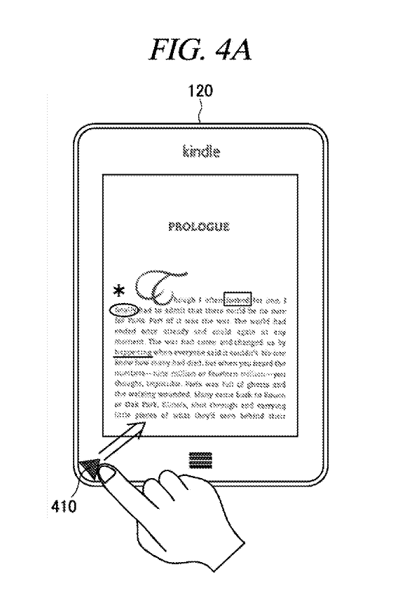

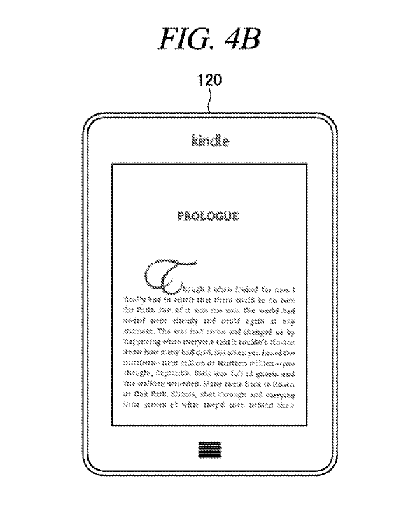

FIGS. 4A and 4B show still another illustrative example device by which at least portions of an electronic book displaying scheme may be implemented, in accordance with various embodiments described herein. As depicted in FIG. 4A, user device 120 may be configured to display multiple annotations (e.g., an asterisk, a circle, a box, underlining, etc.) regarding a page of an electronic book on a display of user device 120; and transmit, to server 140, a request to delete the combined multiple annotations that are displayed on the page of the electronic book upon receiving user input by activating a corresponding command prompt. For example, as depicted in FIG. 4A, a user of user device 120 may touch a portion 410 (e.g., lower left corner) on the display of user device 120, and drag the touch to a predefined direction (e.g., upper right side). Portion 410 is not limited to the upper right corner on the display of user device 120. For example, any portion of the display may be utilized for this purpose; alternatively, any touch pattern on the display may be so implemented. User device 120 may be configured to identify the user touch input, and then to transmit, to server 140, the request to delete the combined multiple annotations from the page of the electronic book.

Server 140 may be configured to retrieve the combined multiple annotations from the page that is displayed on user device 120 upon receiving the request to delete the combined multiple annotations from user device 120. User device 120 may be configured to then display only the original page on which there is no annotation.

Thus, FIGS. 4A and 4B show still another illustrative example device by which at least portions of an electronic book displaying scheme may be implemented, in accordance with various embodiments described herein.

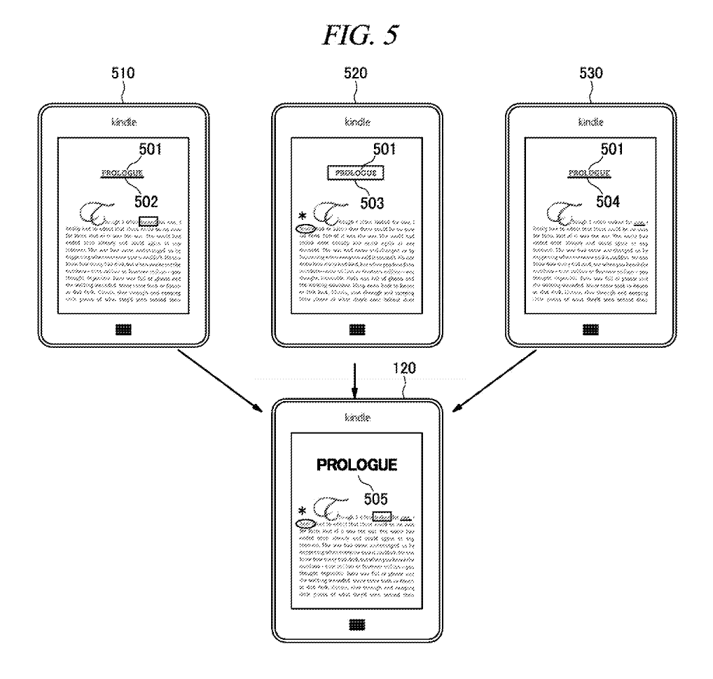

FIG. 5 shows still another illustrative example device by which at least portions of an electronic book displaying scheme may be implemented, in accordance with various embodiments described herein. For example, as depicted in FIG. 5, a first end device 510 may be configured to display a page of an electronic book on a display of first end device 510. Further, first end device 510 may be configured to receive user input to generate a first annotation 502 (e.g., underlining) regarding a word 501 (e.g., the title “PROLOGUE”) on the page of the electronic book; and display first annotation 502 on the page of the electronic book on the display of first end device 510; and transmit first annotation 502 to server 140 when first end device 510 receives user input to turn the page of the electronic book. The event or command that may cause first annotation 502 to be transmitted to server 140 is not limited to turning the page. For example, first end device 510 may transmit, to server 140, first annotation 502 upon receiving a voice command to execute the transmission.

Further, as depicted in FIG. 5, a second end device 520 may be configured to display the same page of the electronic book as on first end device 510. Further, second end device 520 may be configured to receive user input to generate a second annotation 503 (e.g., a box) regarding word 501 (e.g., the title “PROLOGUE”) on the page of the electronic book. Further, second end device 520 may be configured to display second annotation 503 on the page of the electronic book. Second end device 520 may be further configured to transmit second annotation 503 to server 140 when second end device 520 receives user input to turn the page of the electronic book. The event or command that may cause second annotation 503 to be transmitted to server 140 is not limited to turning the page. For example, second end device 520 may transmit, to server 140, second annotation 503 upon receiving a voice command to execute the transmission.

Further, as depicted in FIG. 5, a third end device 530 may be configured to display the same page of the electronic book as displayed on first end device 510 and second end device 520. Further, third end device 530 may be configured to receive user input to generate a third annotation 504 (e.g., underlining) regarding word 501 (e.g., the title “PROLOGUE”) on the page of the electronic book. Further, third end device 530 may be configured to display third annotation 504 on the page of the electronic book, and transmit third annotation 504 to server 140 when third end device 530 receives user input to turn the page of the electronic book. The event or command that may cause third annotation 504 to be transmitted to server 140 is not limited to turning the page. For example, third end device 530 may transmit, to server 140, third annotation 504 upon receiving a voice command to execute the transmission.

In some embodiments, server 140 may be configured to count a number of annotations which are associated with respective one of words on the page of the electronic book. For example, server 140 may be configured to count a number of annotations which are made to word 501. Server 140 may be further configured to determine that three annotations (e.g., first annotation 502, second annotation 503, and third annotation 504) are associated to word 501.

Further, server 140 may be configured to emphasize word 501 on the page based at least in part on the number of annotations which are made to word 501. For example, server 140 may be configured to emphasize word 501 on the page, since three annotations which are greater than a predetermined threshold number (e.g., two annotations) are made to word 501. Server 140 may be configured to emphasize word 501 by changing a color of a font of word 501, a size of the font of word 501, or the font of word 501.

Further, server 140 may be configured to transmit, to user device 120, the page of the electronic book, on which word 501 is emphasized. Then, user device 120 may be configured to display the page of the electronic book on the display of user device 120. For example, as depicted in FIG. 5, a size of a font of word 501 may be increased.

Thus, FIG. 5 shows still another illustrative example device by which at least portions of an electronic book displaying scheme may be implemented, in accordance with various embodiments described herein.

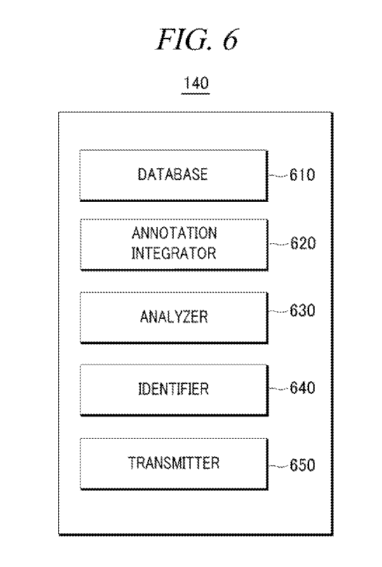

FIG. 6 shows an illustrative example server by which at least portions of an electronic book displaying scheme may be implemented, in accordance with various embodiments described herein. As depicted in FIG. 6, server 140 may include a database 610, an annotation integrator 620, an analyzer 630, an identifier 640 and a transmitter 650. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or any combination thereof. In that regard, one or more of database 610, annotation integrator 620, analyzer 630, identifier 640 and transmitter 650 may be included in an instance of an application hosted on server 140.

Database 610 may be configured to receive multiple annotations that are annotated on a page of an electronic book from respective ones of one or more end devices 130. As non-limiting examples, the annotations may include a manually entered highlighting annotation or a handwritten note. Further, the highlighting annotation may include at least one of an asterisk, a circle, a box, underlining or colored highlighting. A type or kind of highlighting annotation is not limited to an asterisk, a circle, a box, underlining or colored highlighting.

Further, database 610 may be configured to store the received multiple annotations in association with the respective ones of end devices 130. For example, but not as a limitation, database 610 may be configured to store respective annotation, along with an identifier of the respective ones of end devices 130 or a user account which is authenticated on the respective ones of end devices 130 that transmitted the respective annotation to server 140.

Further, database 610 may be configured to receive, from user device 120, a request for one or more of the annotations regarding the page of the electronic book. Further, database 610 may be configured to receive, from user device 120, user input to select one or more annotations that are annotated on the page of the electronic book from an annotation list of options regarding displaying the annotations on the page of the electronic book.

Annotation integrator 620 may be configured to combine two or more of the annotations regarding the page when database 610 receives a request for the two or more of the annotations. Further, annotation integrator 620 may be configured to combine the annotations that correspond to a selected one of the options, which may be identified by the user input.

In some embodiments, annotation integrator 620 may be configured to count a number of words to which at least one annotation is made on the page of the electronic book, and to count a number of annotations that are made to respective one of words on a page of the electronic book. For example, annotation integrator 620 may be configured to count a number of words that are underlined or highlighted on the page of the electronic book. For another example, annotation integrator 620 may be configured to count a number of words to which a handwritten note is attached. For another example, annotation integrator 620 may be configured to count a number of words to which at least one of an asterisk, a circle or a box is attached.

Annotation integrator 620 may be further configured to emphasize one or more words on the page based at least in part on the number of the words to which the at least one annotation are applied and/or the counted number of annotations. For example, annotation integrator 620 may be configured to emphasize a word on the page when the word is underlined or highlighted and a circle or a box is made to the word on the page of the electronic book. Annotation integrator 620 may be configured to emphasize the words by changing a color of a font of the emphasized the words, a size of the font of the emphasized the words, or the font of the emphasized the words.

In some embodiments, annotation integrator 620 may be configured to integrate multiple annotations that are associated with a word. For example, if multiple highlighting annotations and/or multiple handwritten annotations are mage to a particular word on a page of an electronic book, annotation integrator 620 may be configured to integrate the multiple highlighting annotations or multiple handwritten annotations to emphasize the particular word.

Analyzer 630 may be configured to analyze one or more annotations to interpret handwritings which are made on the page of the electronic book by using any well-known alphanumeric character recognition methods. Further, in some embodiments, analyzer 630 may be configured to identify respective words on the page of the electronic book using any well-known alphanumeric character recognition methods. In some embodiments, analyzer 630 may be configured to further recognize an arrow or a line that is drawn between the handwriting and the respective word using well-known alphanumeric character recognition methods. Further, server 140 may be configured to associate and/or connect the identified respective words on the page of the electronic book to handwritings based at least in part on the recognized arrow or line.

Identifier 640 may be configured to attribute the annotations to at least one annotator using profile information regarding end devices 130. For example, but not as a limitation, identifier 640 may be configured to match and/or store respective ones of the annotations with user accounts of users who generated the respective ones of the annotations. The user account may be authenticated on respective ones of end devices 130.

Transmitter 650 may be configured to transmit, to user device 120, combined annotations regarding the page of the electronic book. Transmitter 650 may be further configured to transmit, to user device 120, the annotation list of options regarding displaying the annotations on the page of the electronic book. Further, transmitter 650 may be configured to transmit, to user device 120, an annotator list that identifies one or more annotators (e.g., user accounts authenticated on one or more end devices 130) corresponding to respective ones of the annotations, along with the annotation list of options.

Thus, FIG. 6 shows an illustrative example server by which at least portions of an electronic book displaying scheme may be implemented, in accordance with various embodiments described herein.

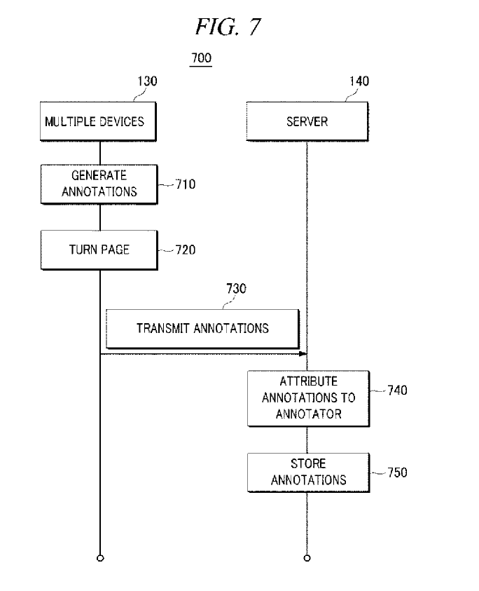

FIG. 7 shows an example processing flow 700 of operations by which at least portions o fan electronic book displaying scheme may be implemented, in accordance with various embodiments described herein. The operations of processing flow 700 may be implemented in system configuration 10 including user device 120, one or more end devices 130, and server 140, as illustrated in FIG. 1. Processing flow 700 may include one or more operations, actions, or functions as illustrated by one or more blocks 710, 720, 730, 740 and/or 750. Although illustrated as discrete blocks, various blocks may be divided into additional blocks, combined into fewer blocks, or eliminated, depending on the desired implementation. Processing may begin at block 710.

Block 710 (Generate Annotations) may refer to multiple end devices 130 generating one or more annotations regarding a page of an electronic book which is displayed on a corresponding display. For example, but not as a limitation, the annotations may include a handwriting that includes at least one of a highlighting annotation or a handwritten note. Further, the highlighting annotation may include at least one of an asterisk, a circle, a box, underlining or colored highlighting. A type or kind of highlighting annotation is not limited to an asterisk, a circle, a box, underlining or colored highlighting. Processing may proceed from block 710 to block 720.

Block 720 (Turn Page) may refer to multiple end devices 130 turning the page on which the one or more annotations have been added. Multiple end devices 130 may receive user input to turn the page, and may turn the page upon receiving the user input. Processing may proceed from block 720 to block 730.

Block 730 (Transmit Annotations) may refer to multiple end devices 130 transmitting, to server 140, the one or more annotations regarding the page of the electronic book. At block 730, respective ones of end devices 130 may transmit, to server 140, the annotations on the page upon receiving the user input to turn the page at block 720. The event or command that may cause the annotations to be transmitted to server 140 is not limited to turning the page. For example, end devices 130 may transmit, to server 140, the annotations on the page upon receiving a voice command to execute the transmission. Processing may proceed from block 730 to block 740.

At block 740 (Attribute Annotations to Annotator) may refer to server 140 attributing the received annotations to at least one annotator using profile information regarding respective ones of end devices 130. At block 740, server 140 may match respective ones of the annotations with user accounts of users who generated the respective ones of the annotations. The user account may be authenticated on respective ones of end devices 130. Processing may proceed from block 740 to block 750.

At block 750 (Store Annotations) may refer to server 140 storing, in a database, the annotations in association with the respective ones of end devices 130. In some embodiments, at block 750, server 140 may store the annotations, along with the at least one annotator (e.g., user account) corresponding the respective ones of the annotations in the database.

Thus, FIG. 7 shows an example processing flow 700 of operations by which at least portions of an electronic book displaying scheme may be implemented, in accordance with various embodiments described herein.

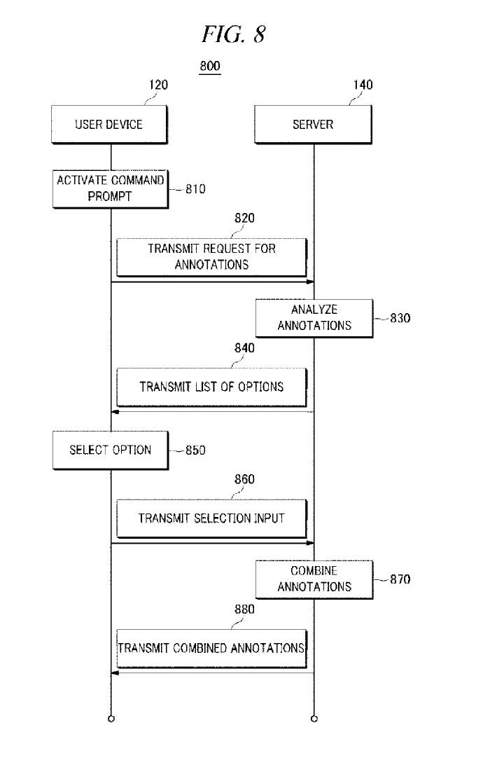

FIG. 8 shows another example processing flow 800 of operations by which at least portions of an electronic book displaying scheme may be implemented, in accordance with various embodiments described herein. The operations of processing flow 800 may be implemented in system configuration 10 including user device 120, one or more end devices 130, and server 140, as illustrated in FIG. 1. Processing flow 800 may include one or more operations, actions, or functions as illustrated by one or more blocks 810, 820, 830, 840, 850, 860, 870 and/or 880. Although illustrated as discrete blocks, various blocks may be divided into additional blocks, combined into fewer blocks, or eliminated, depending on the desired implementation. Processing may begin at block 810.

Block 810 (Activate Command Prompt) may refer to user device 120 activating a corresponding command prompt. For example, at block 810, user device 120 may receive user input to touch a certain portion (e.g., upper right corner) on a display of user device 120, and to drag the touch to a predefined direction (e.g., lower left side of the display) on the display of user device 120. The certain portion is not limited to the upper right corner on the display of user device 120, as described earlier. Processing may proceed from block 810 to block 820.

Block 820 (Transmit Request for Annotations) may refer to user device 120 transmitting, to server 140, a request for annotations regarding a page of an electronic book which is displayed on the display of user device 120. Processing may proceed from block 820 to block 830.

Block 830 (Analyze Annotations) may refer to server 140 analyzing the annotations to interpret handwritings which are included the annotations using any well-known alphanumeric character recognition methods. For example, the handwritings may include at least one of a manually entered highlighting annotation or a handwritten note. Further, the highlighting annotation may include at least one of an asterisk, a circle, a box, underlining or colored highlighting. A type or kind of highlighting annotation is not limited to an asterisk, a circle, a box, underlining or colored highlighting. Processing may proceed from block 830 to block 840.

Block 840 (Transmit List of Options) may refer to server 140 transmitting, to user device 120, an annotation list of options regarding displaying the annotations that are annotated on the page of the electronic book. For example, the annotation list may include a first annotation which is generated by a user of a first device, a second annotation which is generated by a user of a second device and a third annotation which is generated by a user of a third device. Processing may proceed from block 840 to block 850.

Block 850 (Select Options) may refer to user device 120 selecting one or more options from the annotation list of options regarding displaying the annotations on the page of the electronic book. For the above example, at block 850, user device 120 may receive a selection user input to select the first annotation and the second annotation from the annotation list of options. Processing may proceed from block 850 to block 860.

Block 860 (Transmit Selection Input) may refer to user device 120 transmitting, to server 140, the selection user input to select the one or more options regarding displaying the annotations that are annotated on the page of the electronic book. For the above example, at block 860, user device 120 may transmit, to server 140, the selection user input to select the first annotation and the second annotation from the annotation list. Processing may proceed from block 860 to block 870.

Block 870 (Combine Annotations) may refer to server 140 combining the annotations that correspond to the selected one or more options. For the above example, at block 870, server 140 may combine the selected first annotation and second annotation. Processing may proceed from block 870 to block 880.

Block 880 (Transmit Combined Annotations) may refer to server 140 transmitting, to user device 120, the annotations that are combined at block 870. For the above example, at block 880, server 140 may transmit the combined first annotation and second annotation to user device 120. User device 120 may display the received combined first annotation and second annotation together on the page of the electronic book on the corresponding display.

Thus, FIG. 8 shows another example processing flow 800 of operations by which at least portions o fan electronic book displaying scheme may be implemented, in accordance with various embodiments described herein.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

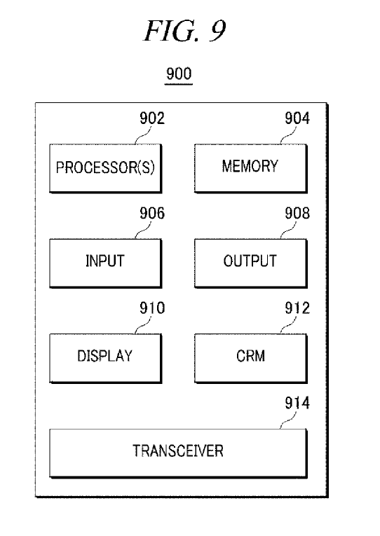

FIG. 9 shows an illustrative computing embodiment, in which any of the processes and sub-processes of an electronic book displaying scheme may be implemented as computer-readable instructions stored on a computer-readable medium, in accordance with various embodiments described herein. The computer-readable instructions may, for example, be executed by a processor of a device, as referenced herein, having a network element and/or any other device corresponding thereto, particularly as applicable to the applications and/or programs described above corresponding to the configuration 10 for transactional permissions.

In a very basic configuration, a computing device 900 may typically include, at least, one or more processors 902, a system memory 904, one or more input components 906, one or more output components 908, a display component 910, a computer-readable medium 912, and a transceiver 914.

Processor 902 may refer to, e.g., a microprocessor, a microcontroller, a digital signal processor, or any combination thereof.

Memory 904 may refer to, e.g., a volatile memory, non-volatile memory, or any combination thereof. Memory 904 may store, therein, an operating system, an application, and/or program data. That is, memory 904 may store executable instructions to implement any of the functions or operations described above and, therefore, memory 904 may be regarded as a computer-readable medium.

Input component 906 may refer to a built-in or communicatively coupled keyboard, touch screen, or telecommunication device. Alternatively, input component 906 may include a microphone that is configured, in cooperation with a voice-recognition program that may be stored in memory 904, to receive voice commands from a user of computing device 900. Further, input component 906, if not built-in to computing device 900, may be communicatively coupled thereto via short-range communication protocols including, but not limitation, radio frequency or Bluetooth.

Output component 908 may refer to a component or module, built-in or removable from computing device 900, that is configured to output commands and data to an external device.

Display component 910 may refer to, e.g., a solid state display that may have touch input capabilities. That is, display component 910 may include capabilities that may be shared with or replace those of input component 906.

Computer-readable medium 912 may refer to a separable machine readable medium that is configured to store one or more programs that embody any of the functions or operations described above. That is, computer-readable medium 912, which may be received into or otherwise connected to a drive component of computing device 900, may store executable instructions to implement any of the functions or operations described above. These instructions may be complimentary or otherwise independent of those stored by memory 904.

Transceiver 914 may refer to a network communication link for computing device 900, configured as a wired network or direct-wired connection. Alternatively, transceiver 914 may be configured as a wireless connection, e.g., radio frequency (RF), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A server, comprising:
a database configured to receive, from multiple devices, annotations regarding a page of an e-book;
an annotation integrator configured to combine two or more of the annotations regarding the page; and
a transmitter configured to transmit, to a user device, the combined annotations regarding the page of the e-book.

2. The server of claim 1, wherein the transmitter is further configured to transmit, to the user device, a list of options regarding displaying annotations on the page of the e-book, and
wherein the annotation integrator is further configured to combine the two or more annotations corresponding to a selected one of the options.

3. The server of claim 1, wherein the annotation integrator is configured to combine the two or more multiple annotations when the database receives, from the user device, a request for the two or more annotations regarding the page.

4. The server of claim 1, further comprising:
an analyzer configured to analyze one or more of the multiple annotations to interpret handwriting on the page of the e-book.

5. The server of claim 4, wherein the handwriting includes at least one of a highlighting annotation or a handwritten note.

6. The server of claim 5, wherein the highlighting annotation includes at least one of an asterisk, a circle, a box, underlining or colored highlighting.

7. The server of claim 5, wherein the analyzer is further configured to associate a word on the page of the e-book to the handwriting.

8. The server of claim 6, wherein the annotation integrator is further configured to count a number of words that are underlined or highlighted on the page of the e-book.

9. The server of claim 8, wherein the annotation integrator is further configured to emphasize one or more words on the page based at least in part on the number of words that are underlined or highlighted on the page of the e-book.

10. The server of claim 9, wherein the annotation integrator is further configured to emphasize the one or more words by changing a color of a font of the emphasized one or more words, a size of the font of the emphasized one or more words, or the font of the emphasized one or more words.

11. The server of claim 9, wherein the annotation integrator is further configured to integrate multiple highlighting annotations to emphasize the one or more words.

12. The server of claim 7, wherein the analyzer is further configured to identify a word on the page of the e-book that is associated with the handwriting based at least in part on an arrow or a line that is drawn between the handwriting and the word.

13. The server of claim 7, wherein the annotation integrator is further configured to integrate multiple handwritten annotations associated with the word onto the page of the e-book.

14. The server of claim 3, further comprising:
an identifier configured to attribute one or more of the annotations to an annotator by using profile information regarding the user device and/or the at least one other user device.

15. The server of claim 14, wherein the transmitter is further configured to transmit, to the user device, a list that identifies one or more annotators corresponding to respective ones of the annotations.

16. A computer-readable storage medium having thereon computer-executable instructions that, in response to execution, cause a device to perform operations, comprising:
receiving, from multiple devices, annotations regarding a page of an e-book;
combining two or more of the annotations regarding the page from among the annotations; and
transmitting, to a user device, the combined two or more of the annotations.

17. A system, comprising:
a user device configured to:
transmit a request for annotations regarding a page of an e-book; and
a server configured to:
combine multiple annotations made to the page of the e-book, and
transmit, to the user device, the combined annotations, and
wherein the user device is further configured to display the combined annotations.

18. The system of claim 17, wherein the user device is further configured to transmit, to the server, the request for the annotations regarding the page of the e-book upon receiving a user input by activating a corresponding command prompt.

19. The system of claim 18, wherein the user device is further configured to receive a request to delete the combined annotations by activating a corresponding command prompt.

20. The system of claim 18, wherein the user device is further configured to transmit, to the server, new annotations on a page upon receiving a user input to turn the page when the new annotations have been added to the page.
